(19) United States
(12) Patent Application Publication
(10) Pub. No.: US 2016/0328005 A1
(43) Pub. Date: Nov. 10, 2016

(54) POWER SUPPLY CIRCUIT AND ELECTRONIC DEVICE UTILIZING THE SAME

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventor: MENG-LIANG YANG, Shenzhen (CN)

(21) Appl. No.: 14/804,789

(22) Filed: Jul. 21, 2015

(30) Foreign Application Priority Data
May 8, 2015 (CN) 201510231631.9

(51) Int. Cl. G06F 1/32; G06F 13/40

(52) U.S. Cl. CPC G06F 1/3287; G06F 1/3296; G06F 13/4022; G06F 1/3268

(57) ABSTRACT

A power supply circuit applied in an electronic device includes a first power source interface, a second power source interface, a power terminal, a switch unit, and a delay unit. The first power source interface is coupled to the power terminal The second power source interface is coupled to the power terminal through the switch unit. The power terminal can supply power to the first power source interface, and supply power to the second power source interface through the first delay unit and the first switch unit, after a preset time delayed by the first delay unit.

### FIELD

The subject matter herein generally relates to a power supply circuit and an electronic device utilizing the power supply circuit.

### BACKGROUND

A power distribution board is usually coupled to a plurality of hard disk drives, and supplies power to the hard disk drives. However, when the hard disk drives execute spin up at the time of powering on, an operation current of power supply on the power distribution board will exceed a rated current, which may cause the power distribution board to stop operating or cannot operate normally.

### BRIEF DESCRIPTION OF THE DRAWINGS

Implementations of the present technology will now be described, by way of example only, with reference to the attached figures.

FIG. 1 is a block diagram of a first example embodiment of an electronic device with a power distribution board and a hard disk drive (HDD) mode, wherein the power distribution board comprises a power supply circuit.

FIG. 2 is a circuit diagram of an embodiment of the power supply circuit electrically coupled to the HDD mode of FIG. 1.

FIG. 3 is a block diagram of a second example embodiment of an electronic device comprising a power distribution board and a HDD mode, wherein the power distribution board comprises a power supply circuit.

FIG. 4 is a circuit diagram of an embodiment of the power supply circuit electrically coupled to the HDD mode of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The disclosure will now be described in relation to an electronic device.

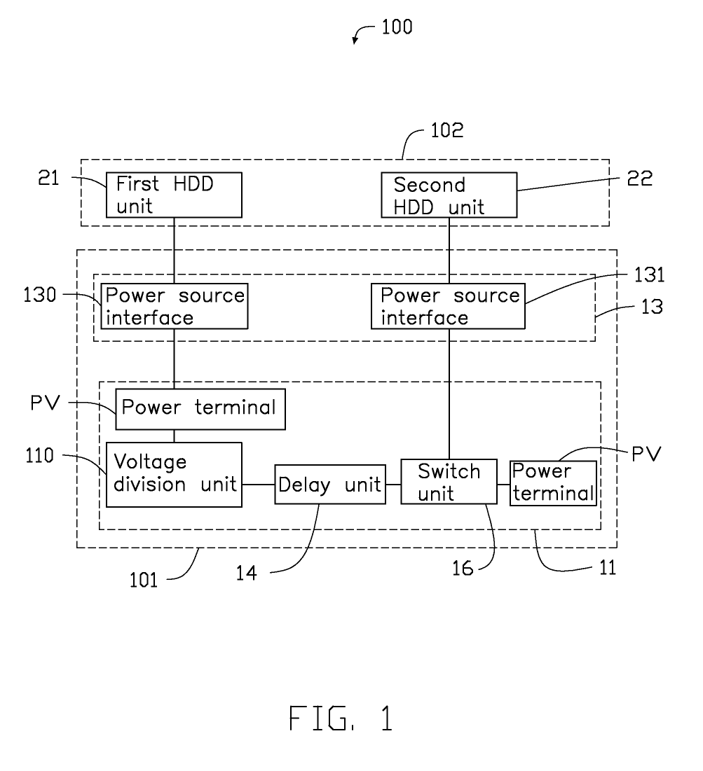

FIG. 1 illustrates a block diagram of a first example embodiment of an electronic device 100 comprising a power distribution board 101 and a hard disk drive (HDD) mode 102. The power distribution board 101 comprises a power supply circuit 11 and an interface unit 13. The power supply circuit 11 comprises an power terminal PV, a voltage division circuit 12, a delay unit 14, and a switch unit 16. The interface 13 comprises two power source interfaces 130, 131. The HDD mode 102 comprises first and second HDD units 21, 22.

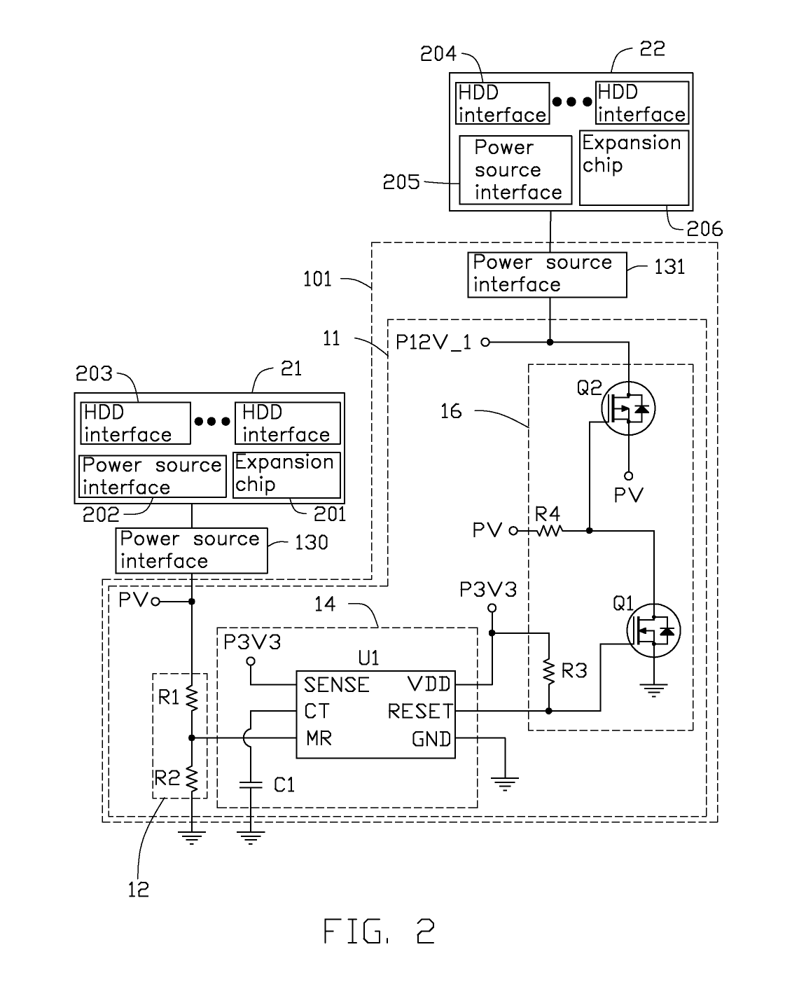

FIG. 2 illustrates a circuit diagram of an embodiment of the power supply circuit 11 electrically coupled to the HDD mode 102 of the first example embodiment of an electronic device 100. Each of the first and second HDD units 21, 22 is a backboard, and is configured to electrically couple to a plurality of hard disks. The first HDD unit 21 comprises an expansion chip 201, a power source interface 202, and a plurality of HDD interfaces 203. The second HDD unit 22 comprises an expansion chip 206, a power source interface 205, and a plurality of HDD interfaces 204. The power source interface 202 is electrically coupled to the power source interface 130 of the power distribution board 101. The power source interface 205 is electrically coupled to the power source interface 131 of the power distribution board 101. Each of the HDD interfaces 203 and the HDD interfaces 204 is electrically coupled to a corresponding HDD. The voltage division unit 12 comprises a resistor R1 and a resistor R2 electrically coupled in series between the power terminal PV and ground.

The delay unit 14 comprises a delay chip U1 and a capacitor C1. A sense pin SENSE of the delay chip U1 is electrically coupled to a first power supply P3V3. A time pin CT of the delay chip U1 is electrically coupled to ground through the capacitor C1. An input pin MR of the delay chip U1 is electrically coupled to a node between the resistor R1 and the resistor R2. A power terminal VDD of the delay chip U1 is electrically coupled to the first power supply P3V3. A reset pin RESET of the delay chip U1 is electrically coupled to the switch unit 16. A delay time of the delay chip U1 can be adjusted by a change in the capacitance of the capacitor C1.

The switch unit 16 comprises resistors R3 and R4, and electronic switches Q1 and Q2. A first terminal of the electronic switch Q1 is electrically coupled to the reset pin RESET of the delay chip U1, and is electrically coupled to the power supply P3V3 through the resistor R3. A second terminal of the electronic switch Q1 is coupled to ground, and is electrically coupled the power terminal PV through the resistor R4. A first terminal of the electronic switch Q2 is electrically coupled to a third terminal of the electronic switch Q1. A second terminal of the electronic switch Q2 is electrically coupled to the power terminal PV. A third terminal of the electronic switch is electrically coupled the power source interface 131. In the embodiment, the electronic switch Q1 is an n-channel metal oxide semiconductor field-effect transistor (NMOSFET). The electronic switch Q2 is a p-channel metal oxide semiconductor field-effect transistor (PMOSFET). First to third terminals of each electronic switch correspond to a gate, a source, and a drain of the MOSFET, respectively.

When the power distribution board 101 is powered on, the power terminal PV outputs a voltage signal of 12 volts (Vs) to the first HDD unit 21 through the power source interface 130.

When the input pin MR of the delay chip U1 receives a digital high signal , such as logic 1, from the node between the resistors R1 and R2, the time pin CT of the delay chip U1 begins operation. After a preset delay time, such as 10 seconds, the reset pin RESET of the delay chip U1 outputs a digital high level signal to the first terminal of the electronic switch Q1, and the electronic switch Q1 is turned on. The source of the electronic switch Q1 outputs a digital low level signal, such as logic 0 to the first terminal of the electronic switch Q2, and the electronic switch Q2 is turned on. The source of the electronic switch Q2 outputs the voltage signal of 12V from the power terminal PV to the power source interface 131, and supplies power to the second HDD unit 22 through the power source interface 131.

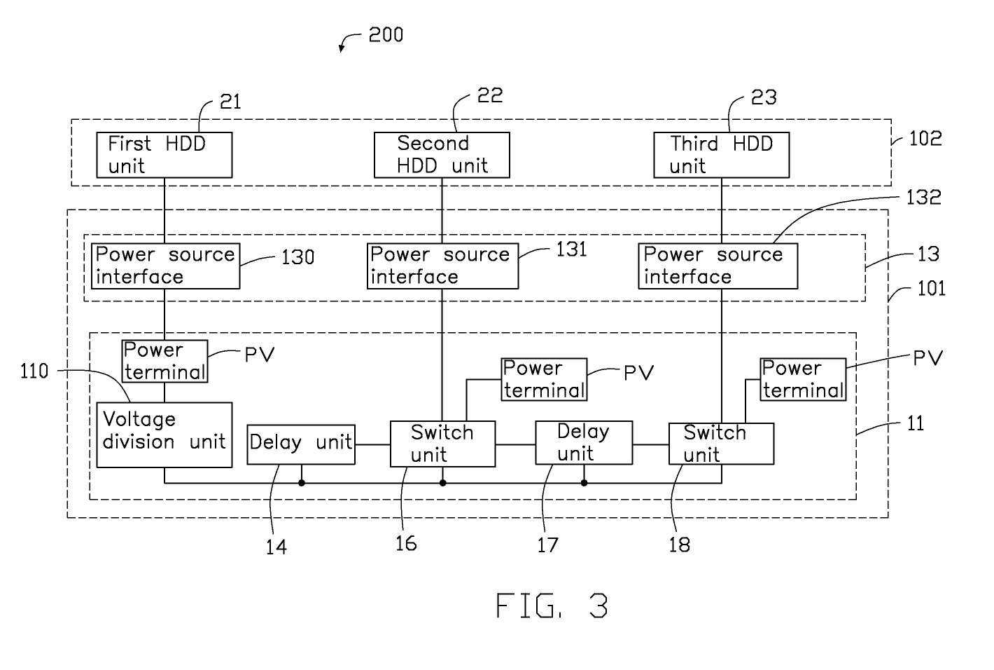

FIG. 3 illustrates a block diagram of a second example embodiment of an electronic device 200 further comprising a third HDD unit 23, a power source interface 132, a delay unit 17, and a switch unit 18 on the first example embodiment of an electronic device 100. A structure of the third HDD unit 23 is the same as the first HDD unit 21 and the second HDD unit 22.

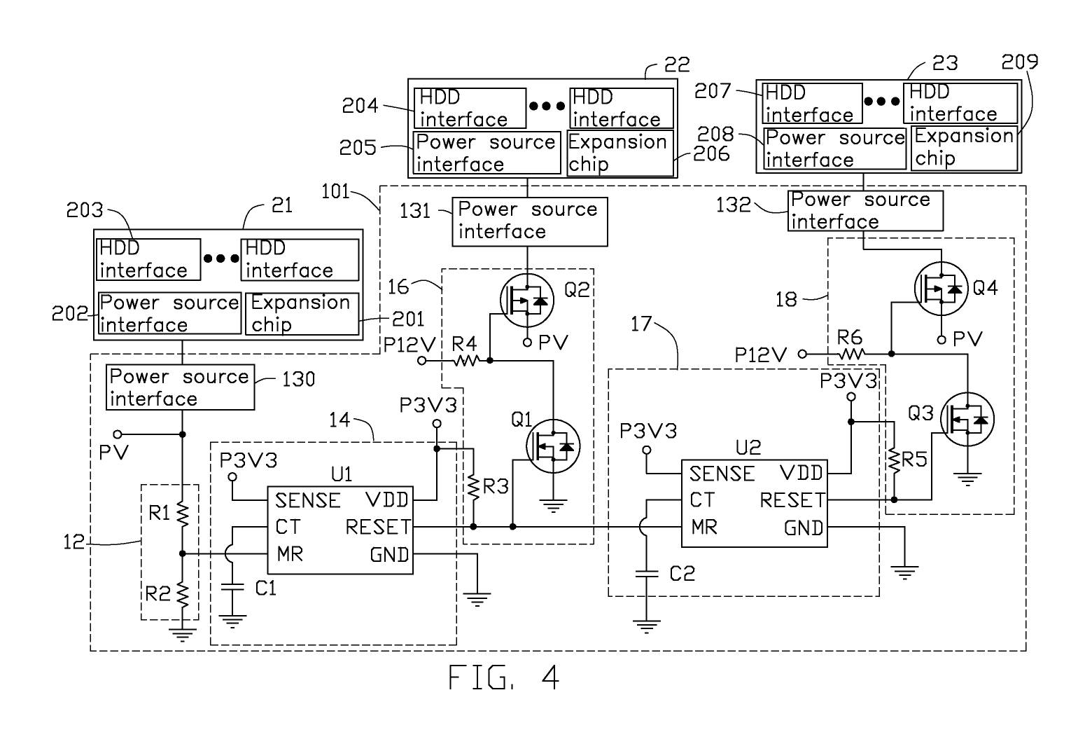

FIG. 4 illustrates a circuit diagram of an embodiment of the power supply circuit 11 electrically coupled to the HDD mode 102 of the second example embodiment of an electronic device 200. The third HDD unit 23 comprises a expansion chip 209, a power source interface 208, and a plurality of HDD interfaces 207. A structure of the delay unit 17 is the same as that of delay unit 14. The delay unit 17 comprises a delay chip U2 and a capacitor C2. A structure of the switch unit 18 is the same as that of the switch unit 16, and comprises resistors R5,R6 and electronic switches Q3, Q4.

An input pin of the delay chip U2 is electrically coupled to the reset pin RESET of the delay chip U1. A time chip CT of the delay chip U2 is coupled to ground through the capacitor C2. A sense pin SENSE and a power pin VDD of the delay chip U2 are electrically coupled to the first power supply P3V3. A reset pin RESET of the delay chip U2 is electrically coupled to the first power supply P3V3 through the resistor R5. A first terminal of the electronic switch Q3 is electrically coupled to the reset pin RESET of the delay chip U2. A second terminal of the electronic switch Q3 is coupled to ground. A third terminal of the electronic switch Q3 is electrically coupled to the second power supply P12V through the resistor R6. A first terminal of the electronic switch Q4 is electrically coupled to the third terminal of the electronic switch Q3. A second terminal of the electronic switch Q4 is electrically coupled to the power terminal PV. A third terminal of the electronic switch Q4 is electrically coupled to the power source interface 132. A delay time of the delay chip U2 can be adjusted by changing the capacitance of the capacitor C2. In the embodiment, the electronic switch Q3 is an n-channel metal oxide semiconductor field-effect transistor (NMOSFET). The electronic switch Q4 is a p-channel metal oxide semiconductor field-effect transistor (PMOSFET). First to third terminals of each electronic switch correspond to a gate, a source, and a drain of the MOSFET, respectively.

When the power distribution board 101 is powered on, the power terminal PV outputs a voltage signal of 12V to the first HDD unit 21 through the power source interface 130.

When the input pin MR of the delay chip U1 receives a digital high signal from the node between the resistors R1 and R2, the time pin CT of the delay chip U1 begins operating. After a preset delay time, such as 10 seconds, the reset pin RESET of the delay chip U1 outputs a digital high level signal to the first terminal of the electronic switch Q1. The electronic switch Q1 is turned on, and outputs a digital low level signal to the first terminal of the electronic switch Q2. The electronic switch Q2 is turned on. The source of the electronic switch Q2 outputs the voltage signal of 12V from the power terminal PV to the power source interface 131, and supplies power to the second HDD unit 22 through the power source interface 131.

When the input pin MR of the delay unit U2 receives a digital high level signal from the reset pin RESET of the delay unit U1, the time pin CT of the delay chip U2 begins to operate. After a preset delay time, such as 10 seconds, the reset pin RESET of the delay chip U2 outputs a digital high level signal to the first terminal of the electronic switch Q3. The electronic switch Q1 is turned on, and outputs a digital low level signal to the first terminal of the electronic switch Q4. The electronic switch Q4 is turned on. The source of the electronic switch Q4 outputs the voltage signal of 12V from the power terminal PV to the power source interface 132, and supplies power to the second HDD unit 23 through the power source interface 132.

In other embodiments, the number of the HDD units, the delay unit, the switch unit, and the power source interface can be adjusted, according to requirements.

Therefore, when the first to third HDD units 21,22,23 can be booted sequentially, through the delay units 14, 17 and the switch units 16, 18, which avoids a risk of over-current.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A power supply circuit comprising:
a power terminal;
a first delay unit electrically coupled to the power terminal;
a first power source interface electrically coupled to a first hard disk drive (HDD) unit and the power terminal;
a second power source interface electrically coupled to a second HDD unit; and
a first switch unit electrically coupled to the first delay unit, the second power source interface, and the power terminal;
wherein when the power terminal supplies power to the first power source interface, the first delay unit delays a preset time, and then outputs an enable signal to the first switch unit, the first switch unit operates and transmits a voltage from the power terminal to the second power source interface.

2. The power supply circuit of claim 1, further comprising a voltage division unit, wherein the first delay unit comprises a first delay chip and a first capacitor, an input pin of the first delay chip is electrically coupled to the power terminal through the voltage division unit, a time pin of the first delay chip is coupled to ground through the first capacitor, a sense pin and a power pin of the first delay chip are electrically coupled to a first power supply, a reset pin of the first delay chip is electrically coupled to the first switch unit, after the delay chip delays a preset time, and the delay chip outputs a control signal to the first switch unit, to make the first switch unit to turn on.

3. The power supply circuit of claim 2, wherein the first switch unit comprises a first resistor, a second resistor, a first electronic switch, and a second electronic switch; a first terminal of the first electronic switch is electrically coupled to the reset pin of the first delay chip, and is electrically coupled to the first power supply through the first resistor; a second terminal of the first electronic switch is coupled to ground; a third terminal of the first electronic switch is electrically coupled to a second power supply through the second resistor; a first terminal of the second electronic switch is electrically coupled to the third terminal of the first electronic switch; a second terminal of the second electronic switch is electrically coupled to the power terminal; and a third terminal of the second electronic switch is electrically coupled to the second power source interface.

4. The power supply circuit of claim 3, further comprising a third power source interface, a second switch unit, and a second delay unit, the third power source interface is electrically coupled to the power terminal through the second switch unit, the second switch unit is electrically coupled between the second delay unit and the third power source interface; when the power terminal supplies power to the second power source interface, the second delay chip operates and delays a preset time, to enable the second switch unit to turn on, and the power terminal can supply power to the third power source interface.

5. The power supply circuit of claim 4, wherein the second delay unit comprises a second delay chip and a second capacitor, an input pin of the second delay chip is electrically coupled to the reset pin of the first delay chip, a time pin of the second delay chip is electrically coupled to ground through the second capacitor, a sense pin of the second delay chip is electrically coupled to the first power supply, a reset pin of the second delay chip is electrically coupled the second switch unit, after the second delay chip delays a preset time, the second delay chip outputs a control signal to enable the second switch unit to turn on.

6. The power supply circuit of claim 5, the second switch unit comprises a third resistor, a fourth resistor, a third electronic switch, and a fourth electronic switch; a first terminal of the third electronic switch is electrically coupled to the reset pin of the second delay chip, and is electrically coupled to the first power supply through the third resistor; a second terminal of the third electronic switch is coupled to ground; a third terminal of the third electronic switch is electrically coupled to the second power supply through the fourth resistor; a first terminal of the fourth electronic switch is electrically coupled to the third terminal of the third electronic switch; a second terminal of the fourth electronic switch is electrically coupled to the power terminal; and a third terminal of the fourth electronic switch is electrically coupled to the third power source interface.

7. The power supply circuit of claim 6, wherein the first and the third electronic switches are n-channel metal oxide semiconductor field-effect transistors (MOSFETs), the second and the fourth electronic switches are p-channel metal oxide semiconductor field-effect transistors (MOSFETs), the first terminal to the third terminal of each electronic switch correspond to a gate, a source, and a drain of the MOSFET, respectively.

8. An electronic device comprising a power distribution board, the power distribution board comprising a power supply circuit, the power supply circuit comprising:
a power terminal;
a first delay unit electrically coupled to the power terminal;
a first power source interface electrically coupled to a first hard disk drive (HDD) unit and the power terminal;
a second power source interface electrically coupled to a second HDD unit; and
a first switch unit electrically coupled to the first delay unit, the second power source interface, and the power terminal;
wherein when the power terminal supplies power to the first power source interface, the first delay unit delays a preset time, and then outputs an enable signal to the first switch unit, the first switch unit operates and transmits a voltage from the power terminal to the second power source interface.

9. The electronic device of claim 8, further comprising a voltage division unit, wherein the first delay unit comprises a first delay chip and a first capacitor, an input pin of the first delay chip is electrically coupled to the power terminal through the voltage division unit, a time pin of the first delay chip is coupled to ground through the first capacitor, a sense pin and a power pin of the first delay chip are electrically coupled to a first power supply, a reset pin of the first delay chip is electrically coupled to the first switch unit, after the delay chip delays a preset time, the delay chip outputs a control signal to the first switch unit, to make the first switch unit to turn on.

10. The electronic device of claim 9, wherein the first switch unit comprises a first resistor, a second resistor, a first electronic switch, and a second electronic switch; a first terminal of the first electronic switch is electrically coupled to the reset pin of the first delay chip, and is electrically coupled to the first power supply through the first resistor; a second terminal of the first electronic switch is coupled to ground; a third terminal of the first electronic switch is electrically coupled to a second power supply through the second resistor; a first terminal of the second electronic switch is electrically coupled to the third terminal of the first electronic switch; a second terminal of the second electronic switch is electrically coupled to the power terminal; and a third terminal of the second electronic switch is electrically coupled to the second power source interface.

11. The electronic device of claim 10, further comprising a third power source interface, a second switch unit, and a second delay unit, the third power source interface is electrically coupled to the power terminal through the second switch unit, the second switch unit is electrically coupled between the second delay unit and the third power source interface; when the power terminal supplies power to the second power source interface, the second delay chip operates and delays a preset time, to enable the second switch unit to turn on, and the power terminal can supply power to the third power source interface.

12. The electronic device of claim 11, wherein the second delay unit comprises a second delay chip and a second capacitor, an input pin of the second delay chip is electrically coupled to the reset pin of the first delay chip, a time pin of the second delay chip is electrically coupled to ground through the second capacitor, a sense pin of the second delay chip is electrically coupled to the first power supply, a reset pin of the second delay chip is electrically coupled the second switch unit, after the second delay chip delays a preset time, the second delay chip outputs a control signal to enable the second switch unit to turn on.

13. The electronic device of claim 12, the second switch unit comprises a third resistor, a fourth resistor, a third electronic switch, and a fourth electronic switch; a first terminal of the third electronic switch is electrically coupled to the reset pin of the second delay chip, and is electrically coupled to the first power supply through the third resistor; a second terminal of the third electronic switch is coupled to ground; a third terminal of the third electronic switch is electrically coupled to the second power supply through the fourth resistor; a first terminal of the fourth electronic switch is electrically coupled to the third terminal of the third electronic switch; a second terminal of the fourth electronic switch is electrically coupled to the power terminal; and a third terminal of the fourth electronic switch is electrically coupled to the third power source interface.

14. The electronic device of claim 13, wherein the first and the third electronic switches are n-channel metal oxide semiconductor field-effect transistors (MOSFETs), the second and the fourth electronic switches are p-channel metal oxide semiconductor field-effect transistors (MOSFETs), the first terminal to the third terminal of each electronic switch correspond to a gate, a source, and a drain of the MOSFET, respectively.
